(19) United States
(12) Patent Application Publication
(10) Pub. No.: US 2025/0153431 A1
(43) Pub. Date: May 15, 2025

(54) PHASE CHANGE INK PRINTING SYSTEM UTILIZING A COMPOSITE WAVEFORM

(71) Applicant: 3D Systems, Inc., Rock Hill, SC (US)

(72) Inventor: Steven Van Cleve Korol, Dundee, OR (US)

(21) Appl. No.: 18/935,811

(22) Filed: Nov. 4, 2024

Related U.S. Application Data
(60) Provisional application No. 63/598,554, filed on Nov. 14, 2023.

(51) Int. Cl. B29C 64/209; B29C 64/112; B29C 64/232; B29C 64/236; B29C 64/393; B33Y 10/00; B33Y 30/00; B33Y 50/02; B33Y 70/00

(52) U.S. Cl. CPC B29C 64/209; B29C 64/112; B29C 64/232; B29C 64/236; B29C 64/393; B33Y 10/00; B33Y 30/00; B33Y 50/02; B33Y 70/00

(57) ABSTRACT

A 3D printing system includes a build plate supporting a 3D article, a drop on demand piezo (DODP) printhead, a horizontal movement mechanism, a supply of phase change ink, and a controller. The controller is configured to: operate the supply and the DODP printhead to maintain a liquid state of the phase change ink, position an upper surface of the 3D article at a build plane, scan the printhead over the upper surface, and operate the DODP printhead to deliver ink drops to pixel locations upon the upper surface. The operation of the DODP printhead includes, for individual ones of the ink drops: apply a secondary waveform to a piezo actuator followed by a primary waveform to the piezo actuator to generate two drops of liquified phase change ink that merge in flight before reaching and solidifying on the upper surface.

### CROSS-REFERENCE TO RELATED APPLICATIONS

This non-provisional patent application claims priority to U.S. Provisional Application Ser. No. 63/598,554, Entitled “PHASE CHANGE INK PRINTING SYSTEM UTILIZING A COMPOSITE WAVEFORM” by Steven Van Cleve Korol, filed on Nov. 14, 2023, incorporated herein by reference under the benefit of U.S.C. 119 (e).

### FIELD OF THE INVENTION

The present disclosure concerns an apparatus and method for fabrication of solid three-dimensional (3D) articles of manufacture from the selective deposition of materials from an inkjet printhead. More particularly, the present disclosure concerns application of a unique method to form large and nominal sized ejected drops with a phase change ink ejected from a heated printhead.

### BACKGROUND

Three-dimensional (3D) printing systems are in rapidly increasing use for purposes such as prototyping and manufacturing. One type of 3D printer utilizes an inkjet printhead to selectively deposit a material to form a three dimensional (3D) article of manufacture. The printhead scans along a “scan axis” and selectively and repeatedly forms layers that cumulatively define the three dimensional (3D) article of manufacture. In some embodiments each layer can be UV cured. In other embodiments phase change inks are used. As known in the art, the term “ink” includes both build materials and support materials.

Phase change inks typically incorporate a wax material. Phase change inks are solid at room temperature or about 25 degrees Celsius. These inks are handled at elevated temperatures in the printing system to facilitate providing the ink to the printhead and ejection. Because they solidify upon impact, these inks do not tend to flow from defined lateral boundaries after dispensing. Thus they enable accurate lateral critical dimensions.

There is a desire to improve a speed of the 3D printing systems and therefore to reduce a time required to form a 3D article. This can be done by utilizing additional 3D printheads, but that adds substantial cost and complexity to the 3D printing system-particularly when phase change inks are utilized. The printheads typically incorporate piezoelectric drop ejectors, rollers, and light sources for ejecting, planarizing, and curing layers of the phase change ink. As a result, the printheads are relatively large and expensive. There is a strong desire to improve the speed of 3D printing systems while maintaining other parameters like number of printheads, scan velocity, and resolution.

### SUMMARY

An aspect of the disclosure is a three-dimensional (3D) printing system for manufacturing a 3D article. The 3D printing system includes a build plate, a drop on demand piezo (DODP) printhead, a horizontal movement mechanism, a supply, and a controller. The build plate is coupled to a vertical movement mechanism. The DODP printhead includes an array or arrayed plurality of piezoelectric (piezo) actuators. The horizontal movement mechanism is configured to impart relative lateral motion between the DODP printhead and the build plate. The supply is coupled to the DODP printhead and contains a phase change ink. The controller is configured to: operate the supply and the DODP printhead to maintain a liquid state of the phase change ink, operate the vertical movement mechanism to position an upper surface at a build plane, operate the horizontal movement mechanism to impart a scanning motion of the printhead with respect to the upper surface, concurrent with operating the horizontal movement mechanism, operate the array of piezo actuators to deliver ink drops to pixel locations upon the upper surface, and further operate the vertical movement mechanism, the horizontal movement mechanism, the supply, and the printhead to complete fabrication of the 3D article in a layer-by-layer manner. The operation of the array of piezo actuators includes, for individual ones of the array of piezo actuators and individual ones of the ink drops: apply a secondary waveform to the piezo actuator including a secondary positive voltage pulse having a maximum magnitude (V_{SP}) followed by a negative voltage pulse having a maximum magnitude (V_{SN}) and apply a primary waveform to the piezo actuator including a primary positive voltage pulse having a maximum magnitude (V_{PP}) followed by a primary negative voltage pulse having a maximum magnitude (V_{PN}) with a limitation that V_{PP}>V_{SP} and V_{PN}>V_{SN}.

The benefit is to provide two substantially different drop volumes of phase change ink with a single piezo nozzle. This is accomplished using two different operating mode waveforms. For a nominal mode waveform, a “nominal” drop volume is generated by operating with the primary waveform and without the secondary waveform. For a large or “composite” drop volume mode waveform, a larger drop volume, having a volume that is at least 50% larger than the nominal drop volume is generated by applying both the secondary and primary waveforms. The nominal mode waveform and the composite drop volume mode waveform have the same total time duration. This provides a phase change printing system with a substantial speed increase without any increase in complexity or associated hardware.

In one implementation, the phase change ink is a solid at 25 degrees Celsius and has a melting point within a range of 60 to 140 degrees Celsius. The phase change ink can contain a phase change component that includes one or more of a hydrocarbon wax, a fatty alcohol wax, a fatty acid wax, a fatty acid ester wax, an aldehyde wax, an amide wax, and a ketone wax. The phase change ink can contain one or more of an oligomer and a monomer plus a catalyst that is activated by ultraviolet radiation. Thus, a phase change ink typically contains a wax component and optionally contains a radiation curable component. The radiation can have a wavelength in the blue to ultraviolet range.

In another implementation, a temporal pulse width of the primary positive pulse has a magnitude that is at least twice a magnitude of a temporal pulse width of the primary negative pulse. Likewise a temporal pulse width of the secondary positive pulse has a magnitude that is at least twice a magnitude of a temporal pulse width of the secondary negative pulse. The longer duration positive pulse draws fluid into a pressure chamber and the shorter duration negative pulse causes ejection of a fluid from the pressure chamber through a nozzle which emerges as a phase change ink drop.

In yet another implementation, the secondary wave form forms a secondary ink drop having a secondary drop velocity magnitude (VEL_{S}). The primary waveform forms a primary ink drop having a primary drop velocity magnitude (VEL_{P}) with a limitation that VEL_{P}>VEL_{S}. As a result of the velocity difference, the primary ink drop merges in flight with the secondary ink drop to form a composite ink drop before reaching one of the pixel locations upon the upper surface. The secondary ink drop has a secondary drop volume magnitude (VOL_{S}). The primary ink drop has a primary drop volume magnitude (VOL_{P}), and VOL_{P}>VOL_{S}. Having the primary and secondary ink drops merge in flight to form a composite drop allows a piezo actuator to deliver a single large drop to a single pixel. This enables the same drop ejection frequency to generate drops of two sizes so that a uniform scan speed can be used.

### BRIEF DESCRIPTION OF THE FIGURES

FIG. 1 is a schematic diagram of a three-dimensional (3D) printing system configured to manufacture a three-dimensional (3D) article.

FIG. 2 is a schematic cross-sectional illustration of an embodiment of a piezoelectric drop ejector that can be a portion of the printhead. The printhead can include a plurality of piezo drop generators that are arranged into an array.

FIG. 3 is a flowchart depicting a method of fabricating a 3D article.

FIG. 4 is a graphical illustration of a composite waveform using normalized parameters.

FIG. 5 is a graphical illustration of a composite waveform having labeled parameters.

FIG. 6 is a graphical illustration of a composite waveform having particular temporal and voltage magnitudes.

FIG. 7 is an illustration of an actual drop ejection in response to the application of a composite waveform.

### DETAILED DESCRIPTION OF THE PREFERRED EMBODIMENTS

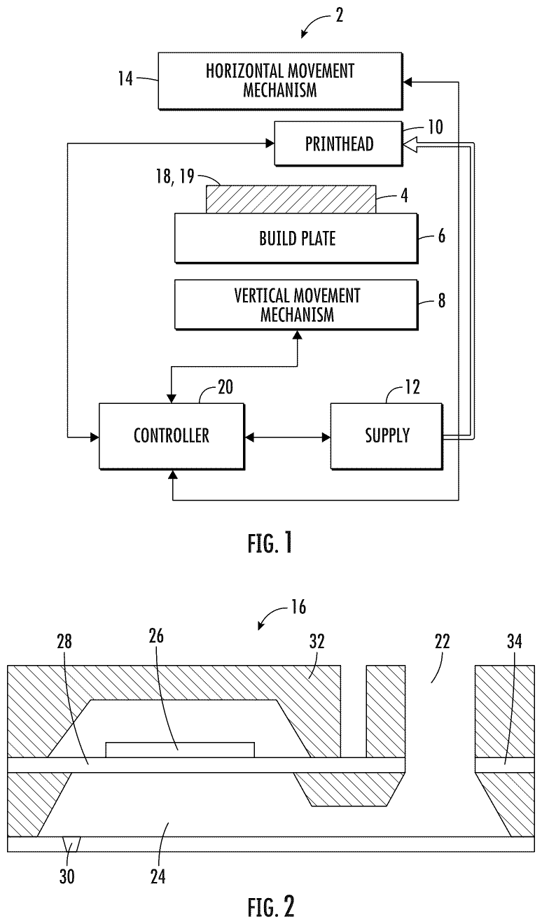

FIG. 1 is a schematic diagram of a three-dimensional (3D) printing system 2 configured to manufacture a three-dimensional (3D) article 4. In describing the printing system 2, mutually orthogonal axes X, Y, and Z can be utilized (but not shown in FIG. 1). The axes X and Y will be referred to “lateral” or “horizontal” axes and Z will be described as a “vertical” axis. However, it is to be understood that Z is not necessarily perfectly aligned with a gravitational reference. Also X will refer to a “scan” axis and Y will refer to a “transverse” axis. The direction+Z is referred to as a generally “upward” direction and −Z is a generally “downward” direction. “Downward” indicates the direction of the gravitational force.

A build plate 6 is configured to support the 3D article 4 being formed or fabricated. A vertical movement mechanism 8 is mechanically coupled to the build plate 6 and is configured to vertically position and move the build plate 6. In one embodiment, the vertical movement mechanism 8 includes a motor, a lead screw, and a nut. The nut is coupled to move vertically with the build plate 6. The motor is rotatively coupled to the lead screw which is threaded through the nut. The motor can be a stepper motor. As the motor rotates the lead screw, the effect is to raise and lower the build plate along vertical Z-axis. An alternative vertical movement mechanism 8 can includes a rack and pinion system. The rack is a linear gear coupled to the build plate. The pinion is a circular gear coupled to a motor and engaged with the linear gear. As the motor turns the pinion, the effect is to raise and lower the build plate. Yet another alternative mechanism can include a motorized belt coupled to the build plate. All such vertical movement mechanisms 8 are known in the art for imparting motion along various axes in 3D printing systems (including X, Y, Z, and oblique axes) and can be used for the vertical movement mechanism 8 and/or the horizontal movement mechanism 14 to be discussed infra.

A drop on demand piezo (DODP) printhead 10 is fluidically coupled to a supply 12 containing and supplying a phase change ink. The supply 12 and printhead 10 include heating elements configured to maintain the ink in a liquid state. The heating elements can be resistive heating elements that individually include a resistor coupled to a power supply. The supply 12 can include a resistively heated bottle or container containing the phase change ink. Resistive heating elements can be incorporated into the container. The supply 12 can also include a flexible tube that fluidically couples the container to the printhead 10. A resistive heating element can be wrapped around the tube. The supply 12 and printhead 10 can also include thermocouples or other temperatures sensors to enable closed loop control of temperature.

The ink is referred to as “phase change” because it is a solid at room temperature or at 25 degrees Celsius but melts and liquifies at an elevated temperature. The ink has a melting point within in a range of 60 to 140 degrees Celsius. More particularly, the ink can have a melting point within a range of 80 to 100 degrees Celsius. The phase change ink can have a plurality of components that have different melting points and may therefore not exhibit a specific or distinct melting point.

In some embodiments, the phase change aspect of the ink is provided by including a wax component. The wax component can include one or more of a hydrocarbon wax, a fatty alcohol wax, a fatty acid wax, a fatty acid ester wax, an aldehyde wax, an amide wax, and a ketone wax. The wax component can provide between 50 and 80 weight percent of the ink or between 60 and 70 weight percent. Other ranges are possible.

The ink can also include a “tackifier” in a range of 5 to 50 weight percent. A tackifier is a resin added to improve immediate adhesion or stickiness of the ink to a surface. The ink can also include a monomer and/or oligomer and a catalyst. The catalyst can cause polymerization and/or cross-linking in the monomer and/or oligomer when irradiated with radiation having spectral peaks within a blue to ultraviolet (100 to 500 nanometer or nm) range. Typically, phase change inks with a monomer/oligomer and catalyst are “build material” inks for forming the 3D article 4 and inks without the monomer/oligomer and catalyst are “support material” inks used to underlie overhanging structures of build material.

The printhead 10 and/or the build plate 6 are mechanically coupled to a horizontal movement mechanism 14. The horizontal movement mechanism 14 is configured to impart relative lateral or horizontal motion between the printhead 10 and the build plate 8. This includes scanning the printhead 10 along a scan axis X relative to the build plate 6. In referring to “scanning the printhead 10” the scan motion can be the printhead moving along X or the build plate moving along X. If the printhead 10 is a “full width” printhead 10, then only one axis of motion is required. If the printhead 10 has a partial width of an area to be printed, then printing may take place in swaths, with a relative movement in Y used to enable full printing of a required area.

For single axis movement (along X), the horizontal movement mechanism 14 can include a single linear or stepper motor that drives a lead screw, a gear train, a rack and pinion, a belt pully, or other mechanism or moving either the build plate 6 or the printhead 10 along X. For two axis movement along X and Y, the horizontal movement mechanism 14 can include a stack of two orthogonal linear or stepper motors that move either the build plate 6 or the printhead 10 along X and Y. In yet another embodiment, the horizontal movement mechanism 14 can include an X-motor moving the printhead 10 and a Y-motor moving the build plate 6. All such variants of horizontal movement mechanisms 14 are known in the art for two and three-dimensional printing. In some embodiments, the horizontal movement mechanism 14 operates on a similar principle or utilizes a very similar mechanism relative to the vertical movement mechanism 8.

The printhead 10 has an array of piezo actuators 16 (FIG. 2) configured to eject ink drops in a downward direction to selectively add material to a top surface 18 of the 3D article 4 (or initially to a top surface 18 of the build plate). From this point forward, element 18 will be referred to as the “top surface”. Element 18 is shown positioned at a same vertical height as a “build plane” 19 which is an area over which the ink drops are selectively applied to pixel locations or pixels. “Pixels” form a rectangular dot matrix pattern to be addressed or printed with ink drops. Pixels and rectangular dot matrix patterns are known in the art for two and three-dimensional printing.

A controller 20 is coupled to the vertical movement mechanism 8, the printhead 10, the phase change ink supply 12, and the horizontal movement mechanism 14. The controller 20 includes a processor coupled to an information storage device. The information storage device stores software instructions that, when executed by the processor, control various portions of the 3D printing system 2. The controller 20, in various embodiments, may be referred to as a computer, a microcontroller, or a server (shared) computer. The controller 20 is programmed to operate components of the printing system 2 to form the 3D article 4 in a layer-by-layer manner.

FIG. 2 is a schematic illustration of an embodiment of a piezoelectric drop ejector 16 that can be a portion of the printhead 10. Ejector 16 includes a fluid manifold 22 that supplies liquified phase change ink to an array of pressure chambers 24, one of which is illustrated in cross section. A piezoelectric element 26 is coupled to a thin membrane 28. The piezoelectric element 26 changes dimension in response to receiving an electrical pulse and, in doing so, flexes the thin film membrane 28. Flexing of membrane 28 can transiently generate a pressure pulse within chamber 24 thereby ejecting a droplet of the liquified phase change ink out of nozzle 30. In this illustrative embodiment, the piezoelectric drop ejector 16 can be formed from etched silicon 32 and deposited thin films 34 of metal, glass, and ceramic. In other embodiments, a piezoelectric drop emitter 16 can be formed from laminated layers of metal and glass. In some embodiments, the piezoelectric drop ejector 16 can be formed from layered stainless steel plates.

An example of a piezoelectric printhead is a Xerox® “M-Series Industrial Inkjet Jetstack”. The Jetstack printheads are at least partially formed from layers of stainless steel and are compatible with a wide range of chemistries.

FIG. 3 is a flowchart depicting a method 40 of fabricating the 3D article 4. Method 40 is performed by controller 20 by controlling and monitoring various portions of 3D printing system 2 including the vertical movement mechanism 8, the printhead 10, the phase change ink supply 12, and the horizontal movement mechanism 14.

According to 42, the printhead 10 and supply 12 are operated to maintain the phase change ink in a liquid state that is suitable for delivery of phase change ink from supply 12 to printhead 10 and for ejection of droplets of ink from printhead 10. This can include passing current through resistive heating elements that are incorporated into portions of the printhead and supply 12. This can also include monitoring thermocouples or other temperature sensors that monitor a temperature of the phase change ink. According to 44, the vertical movement mechanism is operated to position upper surface 18 of build plate 6 or 3D article 4 at the build plane 19.

According to 46, the DODP printhead 10 is scanned over the build plane 19. As described supra, scanning the printhead 10 can include physically moving the printhead 10 and/or physically moving the build plate 6. According to 48—concurrent with scanning the printhead 10, the printhead is operated to deliver ink drops to the upper surface 18. According to 50, steps 44-46 are repeated to complete fabrication of the 3D article 4.

The printhead 10 includes an array of piezo actuators 16. During step 48, the array of actuators 16 are operated to deliver ink drops to pixel locations upon the upper surface 18. For forming an individual drop, a composite voltage waveform 52 is applied to the piezoelectric element 26.

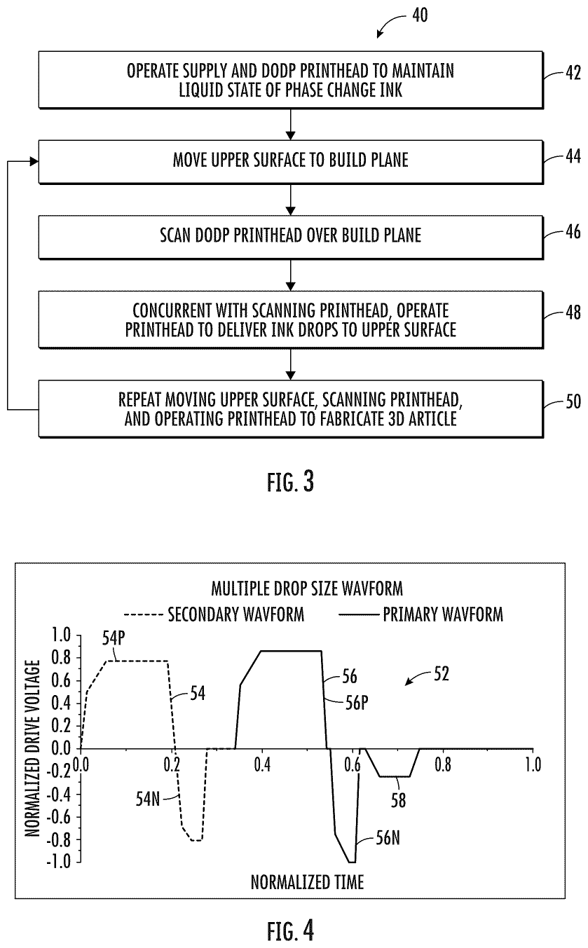

An embodiment of a composite voltage waveform 52 is illustrated in FIG. 4 using normalized (unitless) parameters. The waveform 52 includes various portions now discussed including, in sequence, a secondary waveform 54, a primary waveform 56, and a trailing negative pulse 58. Waveform 54, shown in dashed lines, is referred to as “secondary” because it is not always invoked-sometimes only the primary waveform 56 is applied and other times both waveforms 54 and 56 are applied. The secondary waveform 54 includes a secondary positive pulse 54P followed by a secondary negative pulse 54N. The primary waveform 56 includes a primary positive pulse 56P followed by a primary negative pulse 56N.

The secondary waveform 54 causes the piezo actuator 16 to eject a secondary ink drop having a secondary drop velocity magnitude (VEL_{S}), and a secondary drop volume magnitude (VOL_{S}). The primary waveform 56 causes the piezo actuator 16 to eject a primary ink drop having a primary drop velocity magnitude (VEL_{P}) and a primary drop volume magnitude (VOL_{P}). The primary drop velocity magnitude (VEL_{P}) is greater than the secondary drop velocity magnitude (VEL_{S}). The primary drop volume magnitude (VOL_{P}) is greater than the secondary drop volume magnitude (VOL_{S}). Because of the velocity difference between primary and secondary drops, the primary ink drop “catches up” to the secondary ink drop in flight and merges to form a composite ink drop before reaching the upper surface 18.

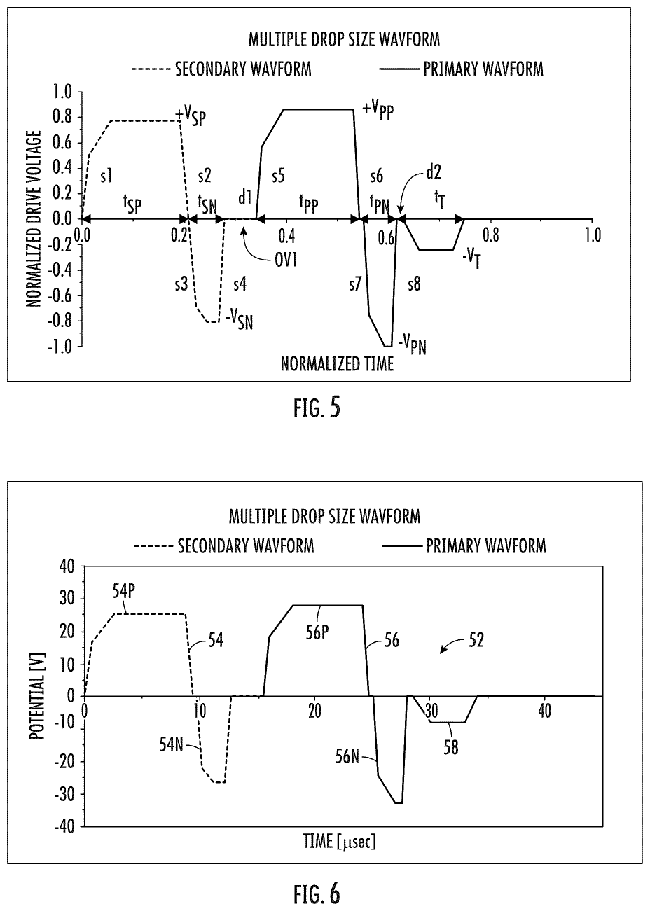

FIG. 5 is similar to FIG. 4 except that some parameters for the composite waveform 52 are labeled. The secondary positive waveform 54P has a maximum (voltage) magnitude (V_{SP}) and a temporal duration (t_{SP}). The secondary negative waveform 54N has a maximum voltage magnitude (V_{SN}) and a temporal duration (t_{SN}). The primary positive waveform 56P has a maximum (voltage) magnitude (V_{PP}) and a temporal duration (t_{PP}). The primary negative waveform 56N has a maximum magnitude (V_{PN}) and a temporal duration (t_{PN}).

Various comparisons between these waveforms are possible. Generally V_{PP}>V_{SP} and V_{PN}>V_{SN}. A ratio of V_{PP}/V_{SP} is in a range of 0.75 to 1.00 or more particularly 0.85 to 0.95. A ratio of V_{PN}/V_{SN} is in a range of 0.75 to 1.25 or more particularly 0.85 to 0.95. Having V_{PP}>V_{SP} and V_{PN}>V_{SN} results in a larger, higher velocity primary drop relative to the secondary drop, allowing the primary drop to merge with the secondary drop in flight.

A ratio of t_{PN}/t_{PP} is in a range of 0.3 to 0.5 or more particularly from 0.3 to 0.4. A ratio of t_{SN}/t_{SP} is in a range of 0.3 to 0.5 or more particularly from 0.3 to 0.4. This is because the positive voltage deflects the membrane 28 upward and this partially “fills” the fluid chamber 24. The negative voltage more rapidly defects the membrane 28 downward and this ejects an ink drop from nozzle 30. (See FIG. 2).

The slopes s1 and s5 represent leading edge positive slopes of the secondary positive pulse 54P and the primary positive pulse 56P respectively. Slopes s1 and s5 are individually within a range of 15 to 80 volts per microsecond or more particularly a range of 26 to 36 volts per microsecond. The slopes s2 and s6 represent trailing edge negative slopes of the secondary positive pulse 54P and the primary positive pulse 56P respectively. The magnitude of slopes s2 and s6 are individually within a range of 19 to 80 volts per microsecond or more particularly within a range of 20 to 47 volts per microsecond.

The slopes s3 and s7 represent leading edge negative slopes of the secondary negative pulse 54N and the primary negative pulse 56N respectively. The magnitude of slopes s3 and s7 are individually within a range of 25 to 80 volts per microsecond or more particularly a range of 31 to 49 volts per microsecond. The slopes s4 and s8 represent trailing edge positive slopes of the secondary negative pulse 54N and the primary negative pulse 56N respectively. Slopes s4 and s8 are individually within a range of 35 and 80 volts per microsecond or more particularly within a range of 37 to 62 volts per microsecond.

Between the secondary 54 and primary 56 waveforms is a first temporal delay having a first time duration (d₁) of 0.25 to 5 microseconds or more particularly of 1 to 3 microseconds. During the first temporal delay, the voltage applied is between −5 and 0 volts and is generally close to zero volts.

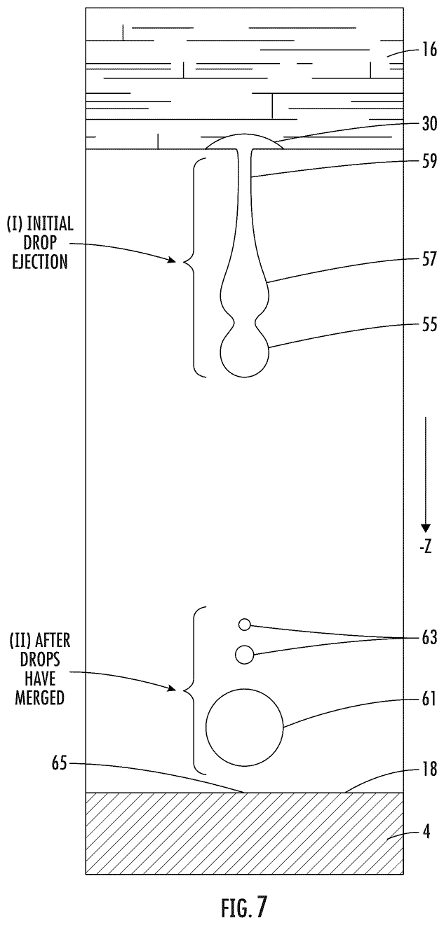

The trailing pulse 58 may be positive or negative in polarity and has an absolute maximum (voltage) magnitude (V_{T}) that is less than 0.35 times V_{PN} or more particularly in a range of 0.2 to 0.3 times V_{PN}. In the illustrated example, the trailing pulse has a negative polarity. The trailing pulse has a time duration t_{T} which is in a range of 3 to 10 microseconds or more particularly in a range of 5 to 7 microseconds. Without the trailing pulse 58, the composite waveform 52 (or the primary waveform 56 by itself) will result in residual oscillations of a fluidic meniscus at the nozzle 30. The trailing pulse 58 is optimized to have an effect of canceling out the residual oscillations and to minimize or optimize a fluidic tail 59 (FIG. 7) that couples ejected drops with the nozzle 30.

Between the primary negative pulse 56P and the trailing pulse 58 is a second temporal delay having a second time duration (d2) of 0.25 to 5 microseconds or more particularly from 0.25 to 1 microsecond. The voltage is nearly zero during the second temporal time delay.

FIG. 6 is similar to FIG. 4 except that actual dimensions of drive voltage (V) in volts versus time (t) in microseconds are used. Thus, FIG. 6 illustrates a particular embodiment of a composite waveform 52. For a lower drop volume or nominal ejection mode, only the primary waveform 56 is applied. For a higher drop volume or composite ejection mode, both secondary 54 and primary 56 waveforms are applied. With the higher drop volume ejection mode, drops from the secondary 54 and primary 56 waveforms merge in flight to form a larger composite drop. This enables a 50% to 100% throughput increase for a printer using a given printhead. In the illustrated embodiment, the composite waveform has a temporal duration of about 45 microseconds regardless of whether the secondary waveform 54 is applied.

As a note, all specific numerical values referred to with respect to FIGS. 4-6 are for a particular embodiment of the printing system 2 for inks having particular properties. For other printing systems 2 and inks, the numerical values may be different.

FIG. 7 is an illustration based upon a pair of high speed and high magnification photographs of the formation of a composite drop 61 of phase change ink in response to the application of a composite waveform 52 to a piezo actuator 16. The illustration superposes two points in time including an (I) earlier top portion labeled “initial drop ejection” and a (II) later bottom portion labeled “after drops have merged”.

When the composite waveform 52 is applied to the piezo actuator 16, a pair of drops emerge from the nozzle 30 as illustrated in the upper portion (I) of the illustration. The secondary waveform 54 generates a secondary ink drop 55. The primary waveform 56 generates a primary ink drop 57. Because of a very short time delay between the application of the secondary 54 and primary 56 waveforms, the drops 55 and 57 are fluidically bridged together by surface tension. A “tail” 59 is also ejected which is temporarily coupled to the nozzle 30.

At this initial (I) point in time the tail 59 lags drops 57 and 55 in speed. Drop 57 has a higher velocity than drop 55. Thus, as time progresses, the tail will tend to lag and break off from drops 57 and 55. Because of the velocity difference between them, drops 55 and 57 will get closer together and merge.

Thus, as time progresses, drops 55 and 57 will merge into a large composite drop 61 due to both the velocity difference and surface tension. The point at which drops 55 and 57 begin to lose their individual spheroid shapes and begin forming one large spheroid should be in a range of 10% to 50% of the distance from the printhead nozzle 30 and the top surface 18 of 3D article 4 or more particularly in a range of 20% to 35% of this distance. The composite drop 61 is shown in the lower illustration (II). Immediately after this point in time, the composite drop 61 will strike the top surface 18 of 3D article 4, at least partially filling a pixel location 65.

The distance—between the nozzle 30 and the surface 18—at which the drops 55 and 57 merge is important. The distance should be far enough away from nozzle 30 to assure jetting stability for the individual drops 55 and 57. At the same time, the distance should be far enough away from the surface 18 to assure that they merge under all 3D printer operational conditions. Such conditions can vary according to duty cycle (density of printing), dither patterns (intentionally applied variation), and a sequence of turning a waveform on and off.

This sequence of drop formation by a composite waveform 52 to form a large composite drop 61 is novel and unique for the use of phase changes inks to form 3D articles. This enables a 3D printer to operate with two different drop sizes including a smaller drop formed with just the primary waveform 56 and a larger composite drop 61 formed with the full composite waveform 52 including the secondary 54 and primary 56 waveforms which form the merging secondary 55 and primary 57 drops respectively.

Finally consider the tail 59. Because it lags drops 55 and 57 in speed, the tail stretches until it breaks, with its break-off point being influenced by the trailing pulse 58. Ideally, the timing of its separation is such that the released portion accelerates due to surface and bulk forces within the fluid toward the composite drop 61. In some circumstances when it breaks, “satellite” drops 63 form which are left from the tail. Because the printhead 10 is being scanned along the X-axis, the satellite drops 63 may not land exactly on top of the composite drop 61.

The specific embodiments and applications thereof described above are for illustrative purposes only and do not preclude modifications and variations encompassed by the scope of the following claims.

What is claimed:

1. A three-dimensional (3D) printing system for manufacturing a 3D article comprising:
a build plate coupled to a vertical movement mechanism;
a drop on demand piezo (DODP) printhead, the DODP printhead including an array of piezoelectric (piezo) actuators;
a horizontal movement mechanism configured to impart relative lateral motion between the DODP printhead and the build plate;
a supply coupled to the DODP printhead and containing a phase change ink;
a controller programmed to:
operate the supply and the DODP printhead to maintain a liquid state of the phase change ink;
operate the vertical movement mechanism to position an upper surface at a build plane;
operate the horizontal movement mechanism to impart a scanning motion of the printhead with respect to the upper surface;
concurrent with operating the horizontal movement mechanism, operate the array of piezo actuators to deliver ink drops to pixel locations upon the upper surface, for individual ones of the array of piezo actuators and individual ones of the ink drops:
apply a secondary waveform to the piezo actuator including a secondary positive voltage pulse having a maximum magnitude (V_{SP}) followed by a negative voltage pulse having a maximum magnitude (V_{SN});
apply a primary waveform to the piezo actuator including a primary positive voltage pulse having a maximum magnitude (V_{PP}) followed by a primary negative voltage pulse having a maximum magnitude (V_{PN});
V_{PP}>V_{SP} and V_{PN}>V_{SN};
further operate the vertical movement mechanism, the horizontal movement mechanism, the supply, and the printhead to complete fabrication of the 3D article in a layer-by-layer manner.

2. The 3D printing system of claim 1 wherein the phase change ink is a solid at 25 degrees Celsius and has a melting point within a range of 60 to 140 degrees Celsius.

3. The 3D printing system of claim 2 wherein the phase change ink contains a phase change component that includes one or more of a hydrocarbon wax, a fatty alcohol wax, a fatty acid wax, a fatty acid ester wax, an aldehyde wax, an amide wax, and a ketone wax.

4. The 3D printing system of claim 3 wherein the phase change ink one or more of an oligomer and a monomer and also contains a radiation activated catalyst.

5. The 3D printing system of claim 1 wherein a temporal pulse width of the primary positive pulse has a magnitude that is at least twice a magnitude of a temporal pulse width of the primary negative pulse.

6. The 3D printing system of claim 1 wherein the secondary wave form forms a secondary ink drop having a secondary drop velocity magnitude (VEL_{S}), the primary waveform forms a primary ink drop having a primary drop velocity magnitude (VEL_{P}), VEL_{P}>VEL_{S}.

7. The 3D printing system of claim 6 wherein the primary ink drop merges in flight with the secondary ink drop to form a composite ink drop before reaching one of the pixel locations upon the upper surface.

8. The 3D printing system of claim 6 wherein the secondary ink drop has a secondary drop volume magnitude (VOL_{S}), the primary ink drop has a primary drop volume magnitude (VOL_{P}), VOL_{P}>VOL_{S}.

9. The 3D printing system of claim 1 wherein a temporal delay d₁ having a temporal duration of 0.25 to 5 microseconds separates the secondary waveform from the first waveform.

10. The 3D printing system of claim 1 wherein a trailing voltage pulse having a maximum magnitude (V_{T}) follows the secondary waveform, V_{T} has a is less than 0.3 times V_{PN} and may be of either positive or negative polarity.

11. A method of manufacturing a three-dimensional (3D) article comprising:
providing a 3D printing system including:
a build plate coupled to a vertical movement mechanism;
a drop on demand piezo (DODP) printhead, the DODP printhead including an array of piezoelectric (piezo) actuators;
a horizontal movement mechanism configured to impart relative lateral motion between the DODP printhead and the build plate;
a supply coupled to the DODP printhead containing a phase change ink;
operating the supply and the DODP printhead to maintain a liquid state of the phase change ink;
operating the vertical movement mechanism to position an upper surface at a build plane;
operating the horizontal movement mechanism to impart a scanning motion of the printhead with respect to the upper surface;
concurrent with operating the horizontal movement mechanism, operating the array of piezo actuators to deliver ink drops to pixel locations upon the upper surface, for individual ones of the array of piezo actuators and individual ones of the ink drops:
applying a secondary waveform to the piezo actuator including a secondary positive voltage pulse having a maximum magnitude (V_{SP}) followed by a negative voltage pulse having a maximum magnitude (V_{SN});
applying a primary waveform to the piezo actuator including a primary positive voltage pulse having a maximum magnitude (V_{PP}) followed by a primary negative voltage pulse having a maximum magnitude (V_{PN});
V_{PP}>V_{SP} and V_{PN}>V_{SN};
further operating the vertical movement mechanism, the horizontal movement mechanism, the supply, and the printhead to complete fabrication of the 3D article in a layer-by-layer manner.

12. The method of claim 11 wherein the phase change ink is a solid at 25 degrees Celsius and has a melting point within a range of 60 to 140 degrees Celsius.

13. The method of claim 12 wherein the phase change ink contains a phase change component that includes one or more of a hydrocarbon wax, a fatty alcohol wax, a fatty acid wax, a fatty acid ester wax, an aldehyde wax, an amide wax, and a ketone wax.

14. The method of claim 13 wherein the phase change ink one or more of an oligomer and a monomer and also contains a ultraviolet activated catalyst.

15. The method of claim 11 wherein a temporal pulse width of the primary positive pulse has a magnitude that is at least twice a magnitude of a temporal pulse width of the primary negative pulse.

16. The method of claim 11 wherein the secondary wave form forms a secondary ink drop having a secondary drop velocity magnitude (VEL_{S}), the primary waveform forms a primary ink drop having a primary drop velocity (VEL_{P}), VEL_{P}>VEL_{S}.

17. The method of claim 16 wherein the primary ink drop merges in flight with the secondary ink drop to form a composite ink drop before reaching one of the pixel locations upon the upper surface.

18. The method of claim 16 wherein the secondary ink drop has a secondary drop volume magnitude (VOL_{S}), the primary ink drop has a primary drop volume magnitude (VOL_{P}), VOL_{P}>VOL_{S}.

19. The method of claim 11 wherein a temporal delay d₁ having a temporal duration of 0.25 to 5 microseconds separates the secondary waveform from the first waveform.

20. The method of claim 11 wherein a trailing negative voltage pulse having a maximum magnitude (V_{T}) follows the secondary waveform, V_{T} has a is less than 0.3 times V_{PN}.

21. A three-dimensional (3D) printing system for manufacturing a 3D article comprising:
a build plate coupled to a vertical movement mechanism;
a drop on demand piezo (DODP) printhead, the DODP printhead including an array of piezoelectric (piezo) actuators;
a horizontal movement mechanism configured to impart relative lateral motion between the DODP printhead and the build plate;
a supply coupled to the DODP printhead and containing a phase change ink;
a controller programmed to:
operate the supply and the DODP printhead to maintain a liquid state of the phase change ink;
operate the vertical movement mechanism to position an upper surface at a build plane;
operate the horizontal movement mechanism to impart a scanning motion of the printhead with respect to the upper surface;
concurrent with operating the horizontal movement mechanism, operate the array of piezo actuators to deliver ink drops to pixel locations upon the upper surface, for individual ones of the array of piezo actuators and individual ones of the ink drops:
select between and operating in one of two operating modes including:
a nominal ejection mode in which a primary waveform is applied to the piezo actuator including a primary positive voltage pulse having a maximum magnitude (V_{PP}) followed by a primary negative voltage pulse having a maximum magnitude (V_{PN}), the piezo actuator in response ejecting a primary ink drop having a primary drop volume magnitude (VOL_{P});
a composite ejection mode in which a composite waveform is applied to the piezo actuator including a secondary waveform followed by a primary waveform, the secondary waveform including a secondary positive voltage pulse having a maximum magnitude (V_{SP}) followed by a negative voltage pulse having a maximum magnitude (V_{SN}), the composite waveform ejecting a secondary ink drop having a secondary drop volume magnitude (VOL_{S}) followed by the primary ink drop to form a composite ink drop having a composite ink drop volume magnitude that is at least at least 150% of the primary drop volume magnitude (VOL_{P});
V_{PP}>V_{SP} and V_{PN}>V_{SN};
further operating the vertical movement mechanism, the horizontal movement mechanism, the supply, and the printhead to complete fabrication of the 3D article in a layer-by-layer manner.

22. The 3D printing system of claim 21 wherein the primary ink drop merges in flight with the secondary ink drop to form a composite ink drop before reaching one of the pixel locations upon the upper surface.

23. The 3D printing system of claim 22 wherein the primary ink drop merges in flight with the secondary ink drop at a vertical distance from the piezo drop generator that has a value of between 10 and 50 percent of a vertical distance between the piezo drop generator and the upper surface.

24. The 3D printing system of claim 22 wherein the primary ink drop merges in flight with the secondary ink drop at a vertical distance from the piezo drop generator that has a value of between 20 and 35 percent of a vertical distance between the piezo drop generator and the upper surface.
